(19) United States
(12) Patent Application Publication
(10) Pub. No.: US 2026/0200135 A1
(43) Pub. Date: Jul. 16, 2026

(54) MACHINE AND METHOD FOR CUTTING SLABS MADE OF STONE OR CERAMIC OR GLASS MATERIAL

(71) Applicant: Luca Toncelli, Bassano del Grappa (VI) (IT)

(72) Inventor: Luca Toncelli, Bassano del Grappa (VI) (IT)

(21) Appl. No.: 19/133,132

(22) PCT Filed: Dec. 4, 2023
(86) PCT No.: PCT/IB2023/062199

§ 371 Date: May 27, 2025

(30) Foreign Application Priority Data
Dec. 7, 2022 (IT) 102022000025248

(51) Int. Cl. B28D 1/04; B24C 1/04; B28D 1/00; B28D 1/22

(52) U.S. Cl. CPC B28D 1/043; B24C 1/045; B28D 1/003; B28D 1/22

(57) ABSTRACT

Machine for cutting slabs made of stone or ceramic or glass material, including a support bench, a machining unit including at least one nozzle for cutting the slabs by means of a high-pressure waterjet with abrasive and a cutting disc designed to form a groove in the slabs along a cutting direction, the cutting disc and the at least one nozzle being mounted on a support head, first and second displacement means intended to displace the machining unit respectively along the cutting direction and along a direction perpendicular to the support bench and first movement means configured to move the at least one nozzle with respect to the support head from a retracted or rest position into an extracted operating position. The machine includes positioning means configured to place the at least one nozzle behind the cutting disc along the cutting direction.

The present invention relates to the technical field of the machining of articles made of stone or ceramic material or similar materials, in particular the cutting of slabs made of stone or ceramic or glass material.

In particular, the present invention relates to a machine and a method for cutting slabs made of stone or ceramic or glass material.

In the prior art machines for cutting slabs, made for example of natural stone, natural stone conglomerate and ceramic or glass material, are known.

Such cutting machines comprise mainly a machining unit provided with cutting means and movable above a bench for supporting the slabs by means of first displacement means and second displacement means.

The cutting means of the machining unit, depending on the type of cut to be performed on the slabs, may comprise a cutting disc, with a respective spindle or at least one nozzle for performing cutting with a high-pressure waterjet and a dispersed abrasive or a combination of the cutting disc and the nozzle.

Generally, the cutting disc is used to perform straight cuts on the slabs, while the nozzle for performing cutting with a water jet and abrasive is used to perform precision cuts or curved cuts; the cutting disc and the nozzle are therefore used as an alternative to each other.

The cutting disc feeding speed is adjusted usually in a range of between 1 and 15 m/min. and the feeding speed of the at least one nozzle is adjusted usually within a range of between 0.1 and 0.5 m/min., depending on the type of material and the thickness of the slabs, which normally ranges between 6 and 40 mm.

Generally, the diamond-coated rim of the cutting disc has a thickness of about 3-4 mm and generates a cutting groove of a few tenths of a mm, while the water jet with abrasive has a diameter of about 1 mm.

Furthermore, the cutting groove formed by the cutting disc has a pair of bottom vertices located on opposite sides of the groove.

The first displacement means and the second displacement means may be of the Cartesian or anthropomorphic type.

In the first embodiment, the first displacement means comprise usually a longitudinal beam slidably supported at its ends by a pair of transverse support shoulders or structures and a carriage slidably mounted on the beam.

By means of these displacement means it is possible to move the machining unit along two mutually perpendicular cutting directions which lie in a plane parallel to the support bench or alternatively along further paths by means of interpolation.

Furthermore the second displacement means comprise preferably a sleeve for displacement of the machining unit along a vertical direction perpendicular to the upper surface of the support bench between a raised rest position and a lowered operating position for cutting the slab.

Instead, in the second embodiment, the first displacement means and the second displacement means consist of at least one robotic arm movable in the various directions and therefore of an anthropomorphic structure able to be positioned at any point in the working space and/or to travel along any interpolated path.

The machining unit comprises in addition a head for supporting the cutting disc and the at least one nozzle.

With reference to the embodiments of the displacement means described above, the support head is mounted on the bottom end of the sleeve or the terminal end of the robotic arm so as to be rotatable with respect to the sleeve or the robotic arm at least about a vertical axis.

The support head may also be a bi-rotational head, namely may comprise a fork structure mounted rotatably about the vertical axis on the sleeve or on the robotic arm and a support designed to support the cutting disc and the at least one nozzle, the support being rotatable with respect to the fork about a horizontal axis perpendicular to the vertical axis.

The at least one nozzle may be movable with respect to the support head between a retracted or rest position, when only the disc is used for cutting the slabs, and an extracted operating position, when the slab is cut only using the high-pressure waterjet, and vice versa.

The movement of the nozzle is performed by means of movement means comprising preferably a pneumatic cylinder or a mechanical drive.

The workbench comprises generally a tank containing water for receiving and damping the high-pressure water jets should the nozzle be used for cutting the slabs.

The tank is covered at the top by a disposable surface, usually formed by an interchangeable metal grid and by one or more actual disposable elements positioned on top of the grid.

The grid consists generally of a series of steel profiles which are arranged alongside each other and the disposable elements are made of wood or plastic or elastomeric material.

The present invention relates preferably to the embodiment in which the disposable surface is formed by a series of adjacent steel profiles and by one or more sacrificial elements positioned on top of the profiles.

The cutting disc, when it is used for cutting of the slabs, penetrates to a predetermined depth, about 1 mm, within the thickness of disposable element; therefore, such latter element has the function of avoiding contact between the cutting disc and the metal grid. Furthermore, the high-pressure waterjet also acts on the disposable element, cutting it integrally, and in this way cuts only by a limited amount into the metal grid.

Examples of such machines for cutting the slabs are disclosed in Italian patent No. 102013902145818 and in international patent application No. WO2006/043294.

A first drawback of the technical solutions described above is due to the fact that the disposable elements positioned on top of the grid must be frequently replaced in order to ensure that the function of protection of the metal grid is properly performed.

The frequent operations involving replacement of the disposable elements result in an overall increase in the machining times, considering that these operations are particularly long and complex.

This drawback is accentuated in the processes involving the cutting of slabs made of ceramic material, which are particularly hard, but intrinsically fragile and have internal tensions caused by the firing process.

Consequently, these processes use mainly high-pressure waterjets for the cutting operations, since use of the disc could result in chipping or cracking of the slabs.

However, the high-pressure waterjets rapidly wear the sacrificial elements and therefore these cutting processes require even more frequent replacement of the disposable elements.

Another drawback of the technical solutions mentioned above consists in the fact that adjustment of the positioning of the nozzles behind the cutting disc is usually performed manually and therefore is laborious and difficult.

The main object of the present invention is to provide a machine and a method for cutting slabs of stone or ceramic or glass material, which are able to solve the aforementioned problems.

A particular task of the present invention is to provide a machine for cutting slabs of stone or ceramic or glass material, which requires less maintenance compared to the cutting machines known in the field.

A further task of the present invention is to provide a machine for cutting slabs of stone or ceramic or glass material, which has a greater productivity compared to the machines known in the field and lower management costs.

Another task of the present invention is to provide a machine for cutting slabs of stone or ceramic or glass material, which is able to easily maintain a high degree of precision of cutting of the slabs.

A further task of the present invention is to provide a machine for cutting slabs of stone or ceramic or glass material, which is able to adjust easily the positioning of the nozzle or nozzles for performing cutting using a waterjet situated behind the cutting disc.

A further task of the present invention is to provide a method for cutting slabs of stone or ceramic or glass material, which has a high productivity and is able to cut the slabs with a high degree of precision.

The main tasks and object described above are achieved with a machine and a method for cutting slabs of stone or ceramic material in accordance with claim 1 and claim 18, respectively.

In order to illustrate more clearly the innovative principles of the present invention and its advantages compared to the prior art, at least one example of embodiment of the machine for cutting slabs according to the present invention will be described below with the aid of the attached drawings. In particular, in the figures:

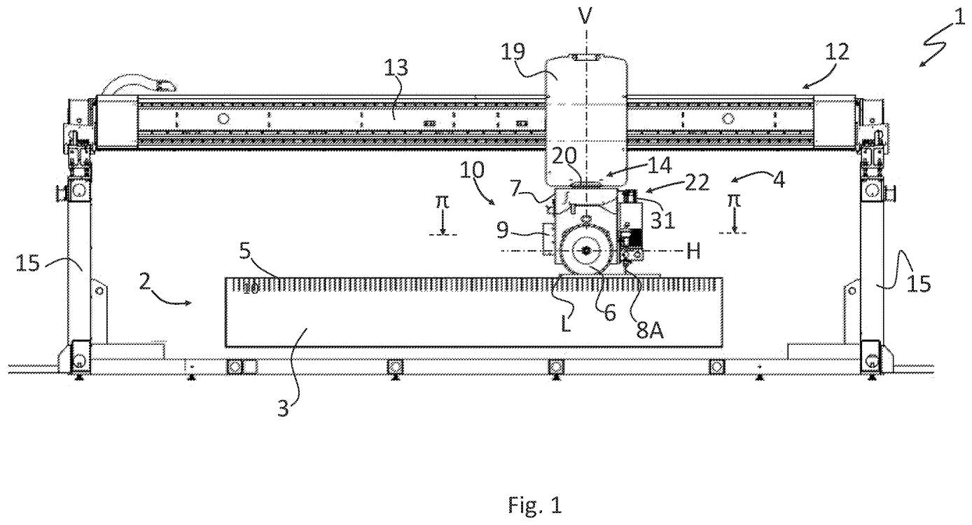

FIG. 1 shows a front view of a first embodiment of the machine for cutting slabs according to the present invention in accordance with a first configuration;

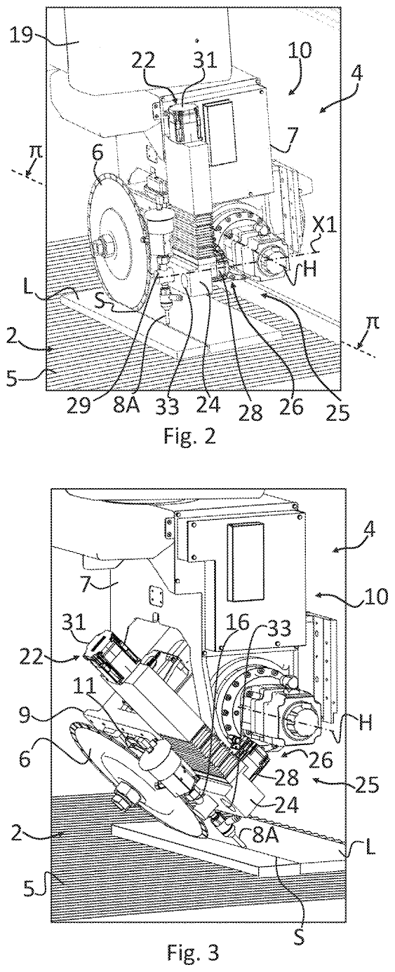

FIGS. 2 and 3 are perspective views of a detail of the cutting machine according to FIG. 1 in two different operating positions;

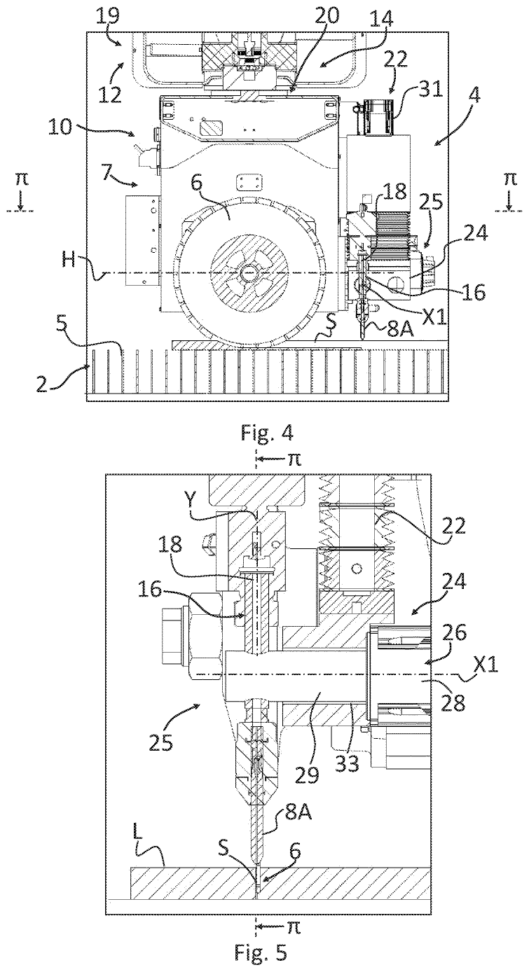

FIG. 4 is a front view, on larger scale, of a detail of the cutting machine according to FIG. 1;

FIG. 5 is a cross-sectional view of a detail of the cutting machine according to FIG. 1;

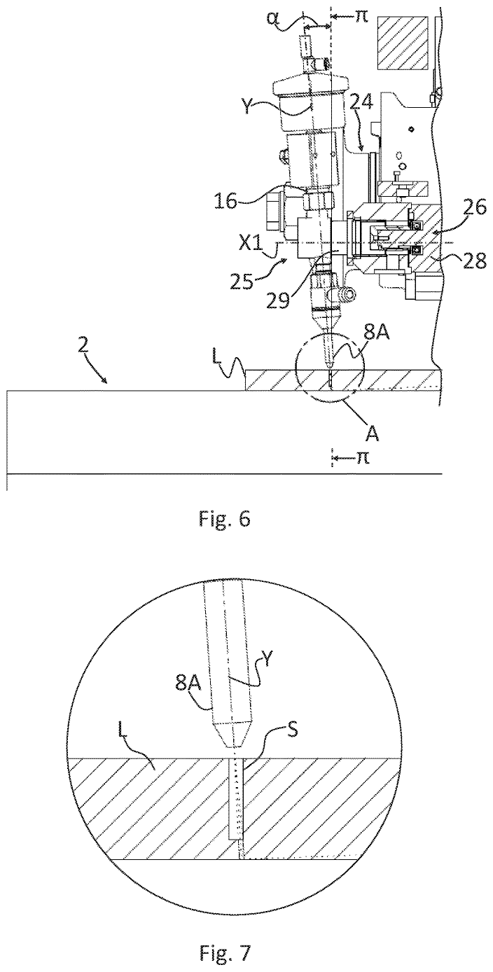

FIGS. 6 and 7 are, respectively, a cross-sectional view and a respective enlargement of a detail (indicated by “A” in FIG. 6) of the first embodiment of the machine in accordance with a second configuration which is an alternative to the first configuration shown in FIGS. 1-5;

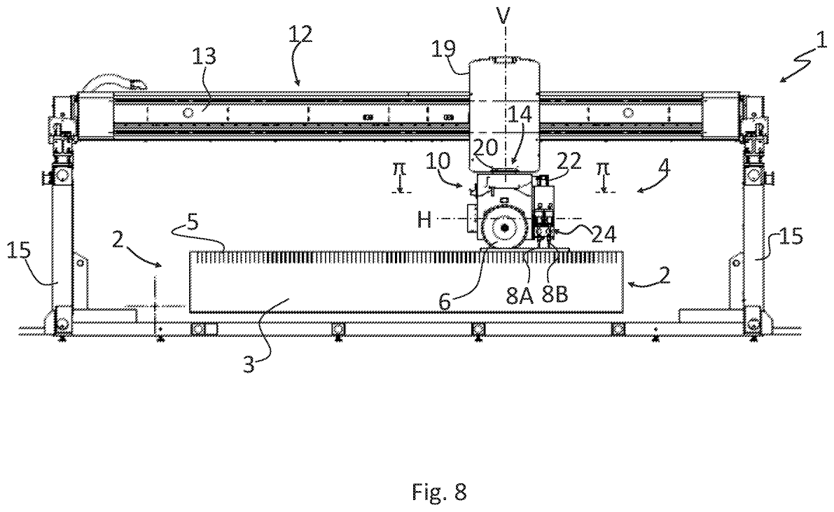

FIG. 8 shows a front view of the first embodiment of the machine for cutting slabs according to the present invention in accordance with a third configuration;

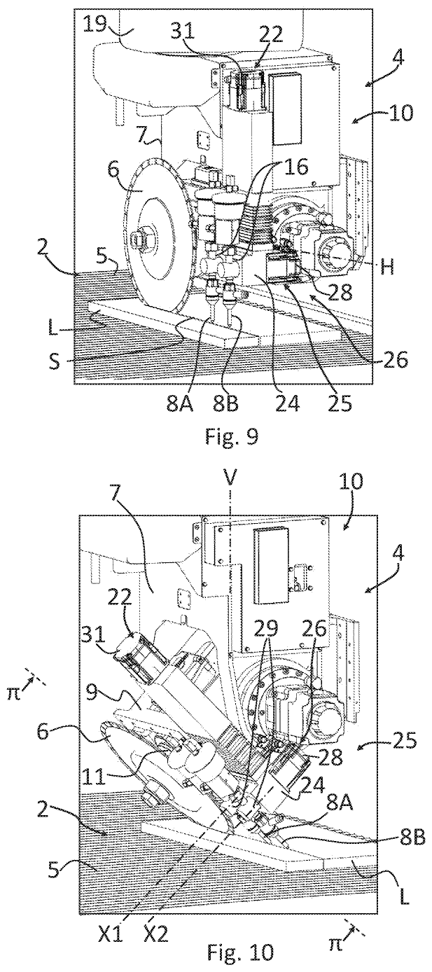

FIGS. 9-12 correspond to FIGS. 2-5 indicated above and refer to the third configuration of the cutting machine of FIG. 8;

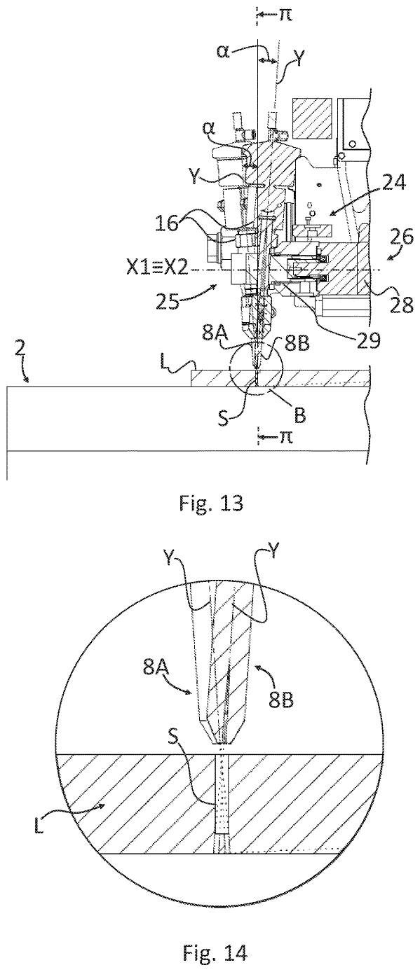

FIGS. 13 and 14 correspond to FIGS. 6 and 7 indicated above and refer to a fourth configuration which is an alternative to the third configuration of the machine shown in FIGS. 8-12; the enlarged detail of FIG. 14 is indicated by “B” in FIG. 13;

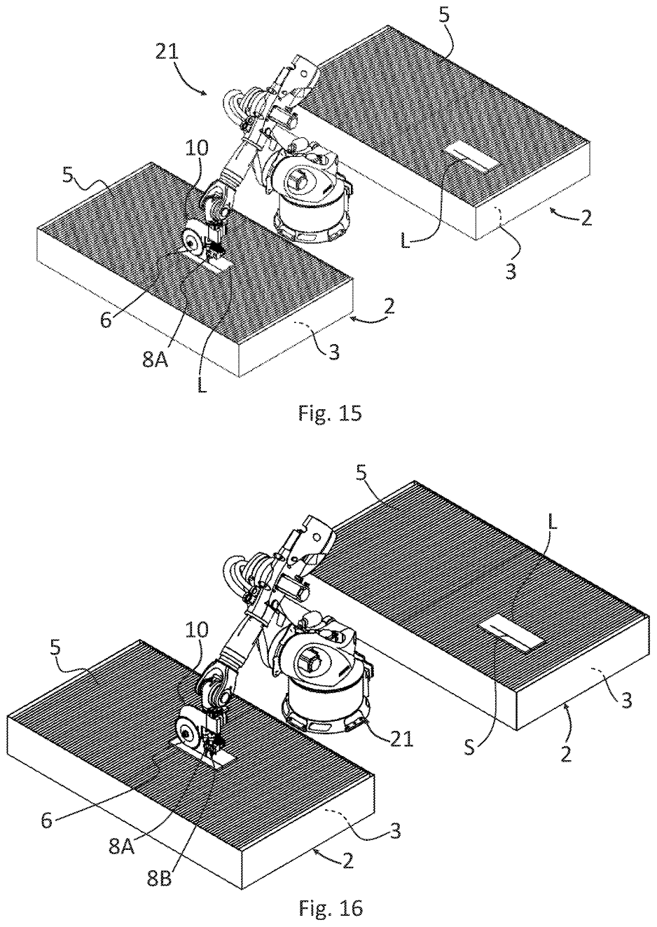

FIGS. 15 and 16 show perspective views of a second embodiment of the machine for cutting slabs according to the present invention in accordance with two different configurations.

The present description, provided only by way of a non-limiting example of the scope of protection of the invention, relates to a machine and a method for cutting slabs of stone or ceramic or glass material; the cutting machine is denoted overall by the reference number 1.

The slabs L to be cut have different shapes and sizes and may be made also using materials different from those indicated above, provided that they have similar structural characteristics.

The cutting machine 1 preferably comprises:
a support bench 2 for the slabs L to be cut;
a machining unit 4 comprising at least one nozzle 8A for cutting the slabs L by means of a high-pressure waterjet with abrasive and a cutting disc 6 which lies in a plane of extension π and is able to form a cutting groove S in the slabs L along a cutting direction, the cutting disc 6 and the at least one nozzle 8A being mounted on a support head 10;
first displacement means 12 and second displacement means 14 intended to displace the machining unit 4 along the cutting direction and along a vertical direction perpendicular to the support bench 2, respectively.

Advantageously, as shown more clearly in FIGS. 1-4 and 8-11, the support bench 2 is formed by a tank 3 and by a metal grid 5, the latter being positioned on the top opening of the tank 2 and forming a sacrificial surface during cutting of the slabs L.

As shown with reference to the second embodiment of FIGS. 15 and 16, the machine may also comprise a pair of support benches 2 of the type indicated above.

The tank 3 is intended to contain water for damping the high-pressure waterjets emitted by the at least one nozzle 8A; in this connection, the height of the water level inside the tank 3 is kept preferably at 70-90 cm from the bottom of the tank 3.

The metal grid 5, since it is intended to undergo the cutting action of the waterjet with abrasive passing through the slab L, is preferably interchangeable.

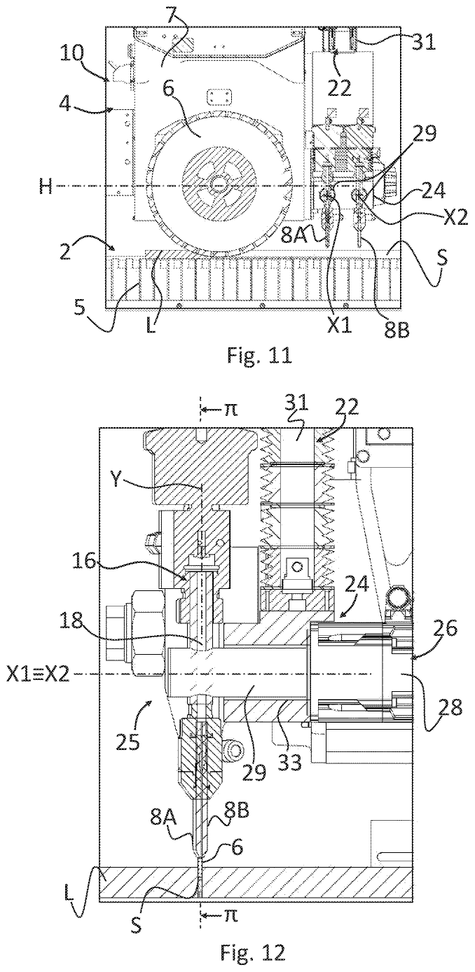

Furthermore, the metal grid 5 consists of a series of steel profiles arranged alongside each other and having normally a height of between 80 and 100 mm and thickness of between 4 and 6 mm, as shown in FIGS. 4 and 11.

Differently from the cutting machines known in the field, the support bench 2 of the cutting machine 1 according to the present invention is devoid of the disposable element, which is normally positioned on top in contact with the metal grid and designed to undergo the action of the rotating cutting disc which penetrates into the slab.

Therefore, in the cutting machine 1 according to the present invention, the metal grid 5 is intended to come directly into contact with the bottom surface of the slabs L to be cut.

This measure, which is also made possible by further technical characteristics of the machine described below, is able to reduce the maintenance required for the machine, since the disposable element is not present, and therefore increase the productivity of the machine and reduce the management costs.

In a first embodiment of the invention shown in FIGS. 1-14 and in particular in FIGS. 1 and 8, the first displacement means 12 are of the Cartesian type and comprise preferably a beam 13 mounted slidably at its ends on respective support structures or transverse shoulders 15 and a carriage 19 mounted slidably on the beam 13.

Suitably, the first displacement means 12 are configured to displace the machining unit 4 along two directions parallel to the support bench 2 and perpendicular to each other, these parallel directions constituting alternatively the direction of cutting of the disc 6; alternatively, the first displacement means 12 may displace the machining unit 4 along different trajectories by means of interpolation.

Furthermore, in this embodiment, the second displacement means 14 comprise preferably a sleeve 20 mounted on the carriage 19 and designed to displace the machining unit 4 along a vertical direction perpendicular to the support bench 2 so as to bring the cutting disc 6 and the at least one nozzle 8A from a raised inoperative position into an operating position opposite the slab L to be cut.

In particular, the second displacement means 14 are configured:
to adjust the distance between the cutting disc 6 and the top surface of the support bench 2;
to keep the cutting disc 6 in the operating position at a predetermined distance or height, preferably at about 1-2 mm, from the top surface of the support bench 2, namely of the grid 5, while it penetrates into the slab L in order to form the groove S.

Therefore, the cutting disc 6 does not penetrate completely into the slab L while it forms the cutting groove S, leaving a residual slab thickness to be cut preferably equal to about 1-2 mm. The cutting groove S formed by the cutting disc 6 also has a pair of bottom vertices located on opposite sides of the cutting groove S.

The support head 10 is mounted on the bottom end of the sleeve 20 and is rotatable relative to the sleeve 20 at least about a vertical axis V, for example by means of a gearmotor mounted on the sleeve 20.

The rotation of the support head 10 about the vertical axis V allows orientation of the cutting disc 6, and consequently the nozzle 8A, along the desired cutting direction.

In the alternative embodiment shown in FIGS. 15 and 16, the first and second displacement means 12, 14 consist of an anthropomorphic robotic arm 21 for displacement of the machining unit 4 at least along the cutting direction.

In the second embodiment, the support head 10 is mounted on the terminal end of the arm 21 and is rotatable relative thereto.

Preferably, and as shown more clearly in FIGS. 2-4 and 9-11, the support head 10 is a bi-rotational fork head with a vertical axis of rotation V (as disclosed above with reference to the rotation of the machining unit 4 relative to the sleeve 20) and a horizontal axis of rotation H.

In particular, said support head 10 comprises a fork 7 rotatably connected to the bottom end of the sleeve 20 and a support 9 rotatable relative to the fork 7 about the horizontal axis H.

The cutting disc 6, with the respective motorized spindle 11 and, in some cases, a protective cover (not shown in the attached figures), and the at least one nozzle 8A, are mounted on the support 9.

In this way, the cutting disc 6 may be moved from a first position in which it is perpendicular to the support bench 2 (see FIGS. 2 and 9) and a second position in which it is inclined with respect to the support bench 2 (see FIGS. 3 and 10), and vice versa, following rotation of the support 9 about the horizontal axis H.

Operatively, the rotation of the head 10 relative to the sleeve 20 allows the cutting direction of the disc 6 and the at least one nozzle 8A to be varied, while the rotation of the support 9 relative to the fork 7 allows the cutting inclination to be varied.

In accordance with alternative embodiments, not shown in the attached figures, instead of the bi-rotational head it is possible to provide a support head having a different configuration, for example a head rotating only about the vertical axis or a support head in which the further axis of rotation is inclined, preferably at 45°, with respect to the vertical axis of rotation.

Furthermore, the at least one nozzle 8A is mounted on a respective body 16, which is mounted in turn on the support head 10 and inside which the water supply line 18 or part thereof is formed, as shown in FIGS. 5 and 12.

The waterjet, to which the suitable abrasive is added, generally has a pressure at the outlet of the nozzle 8A equal to about 3000-6000 bar.

In accordance with the present invention, the cutting machine 1 comprises positioning means 25 configured to position the at least one nozzle 8A behind the cutting disc 6 along the cutting direction, with an orientation such that the waterjet enters into the cutting groove S formed by the cutting disc 6 and strikes one of the bottom vertices thereof (see FIG. 7).

Therefore, the at least one nozzle 8A is arranged behind and slightly offset with respect to the cutting disc 6 along the cutting direction by means of the positioning means 25.

This arrangement, as described more clearly below with reference to the method, ensures that the cutting disc 6 and the at least one nozzle 8A are activated simultaneously during the displacement of the machining unit 4 along the cutting direction, and therefore that:
a cutting groove S, namely a partial cut, is formed in the slabs by means of the cutting disc 6 kept at the predetermined distance or height from the top surface of the support bench 2;
the cut is completed by means of the high-pressure waterjet with abrasive emitted by the at least one nozzle 8A, generating a cutting edge without roughness.

In the third configuration of the cutting machine 1 shown in FIGS. 8-14 and 16, the machining unit 4 comprises a pair of nozzles 8A, 8B of the type disclosed above.

The positioning means 25 of the machine 1 are configured to place the nozzles 8A, 8B behind the cutting disc 6 along the cutting direction and on opposite sides of the plane of extension π of the cutting disc 6, with an orientation such that the respective waterjets enter into the cutting groove S and strike the two bottom vertices thereof (see FIG. 14).

In particular, both the nozzles 8A, 8B of this configuration are arranged behind and slightly offset with respect to the cutting disc 6 along the cutting direction.

Conveniently, the two nozzles 8A, 8B are activated simultaneously during displacement of the machining unit 4 along the cutting direction.

The cutting disc 6 and the nozzles 8A, 8B of the third configuration may also be used singly, instead of in combination, for cutting of the slabs L.

Advantageously, considering that the width of the cut performed by the disc 6 is about 3-4 mm and the diameter of the waterjet is about 1 mm, the combined use of two nozzles 8A, 8B arranged on opposite sides of the cutting disc 6 ensures that cutting edges with a uniform surface are generated, without roughness on both sides of the cut performed.

If the machine uses instead a single nozzle 8A, hence in the first configuration, the cut slab part, the side of which is not affected by the action of the waterjet, may have roughness and therefore constitute machining waste.

In order to be certain that the waterjet or the waterjets prevent the formation of roughness in the slabs L, striking the bottom vertex of the groove S formed by the cutting disc 6, preferably the at least one nozzle 8A or the nozzles 8A, 8B are oriented so as to have an angle of inclination α of between 1° and 6° with respect to the plane of extension π of the cutting disc 6, as illustrated in FIGS. 6 and 13.

In this connection, the positioning means 25 are configured to direct the at least one nozzle 8A or the nozzles 8A, 8B within the angle of inclination indicated above.

Such angle of inclination α of the at least one nozzle 8A or of the nozzles 8A, 8B with respect to the plane of extension π of the cutting disc 6 may be advantageously maintained both when the cutting disc 6 is in the vertical position and when it is in the inclined position with respect to the support bench 2.

In this way, the waterjets enter inside the groove S formed by the cutting disc 6, without colliding along the sides of the said groove S.

The cutting machine 1 further comprises first movement means 22 configured to move the at least one nozzle 8A or the nozzles 8A, 8B with respect to the support head 10 from a retracted or rest position into an extracted operating position in order to perform cutting of the slabs by means of the emission of the high-pressure waterjet with abrasive. Operatively, in the rest position the nozzles 8A, 8B are kept raised at a height of about 2-10 cm from the slab L, while in the operating position the nozzles 8A, 8B are kept close to the slab L at a distance of about 1.5-3 mm.

As illustrated more clearly in FIGS. 2-6 and 9-13, the at least one nozzle 8A or the nozzles 8A, 8B are mounted on a slide 24, the slide 24 being moved by the first movement means 22 which act directly on the slide 24.

Therefore, in the configurations which envisage a pair of nozzles 8A, 8B, these nozzles 8A, 8B are moved simultaneously and in combination between the rest position and the operating position by means of the first movement means 22 which act on the slide 24. Conveniently, the positioning means 25 of the cutting machine 1 may comprise second movement means 26 configured to move the at least one nozzle 8A with respect to the support head 10 at least along a direction of movement X1 perpendicular to the plane of extension π of the cutting disc 6

In the operating position of the machining unit 4, shown more clearly in FIGS. 2 and 5 and 9 and 12, in which the plane of extension π of the cutting disc 6 is in a vertical position perpendicular to the support bench 2, the direction of movement X1 of the at least one nozzle 8A is substantially horizontal and parallel to the support bench 2.

In the third configuration of the machine 1 which envisages a pair of nozzles 8A, 8B, the second movement means 26 are configured to move at least one of the nozzles or both the nozzles 8A, 8B along respective directions X1, X2 perpendicular to the plane of extension π of the cutting disc 6.

The second movement means 26 allow the nozzles 8A, 8B to be suitably directed with respect to the cutting disc 6.

In this way, the cut performed by means of the waterjet or the two waterjets is precise and does not require the use of the disposable element, reducing the maintenance operations to be carried out on the machine.

The at least one nozzle 8A or the nozzles 8A, 8B may be moved by the second movement means 26 along the respective directions X1, X2, keeping the angle of inclination α within about 1° and 6° with respect to the plane of extension π of the cutting disc 6.

The first movement means 22 and the positioning means 25, namely the second movement means 26, are mounted on the machining unit 4, in particular on the support head 10.

Therefore, these means perform all the movements described above with reference to the first displacement means 12, the second displacement means 14 and the rotations of the support head 10.

As clearly illustrated in FIGS. 2-5 and 9-12, the first movement means 22 for moving the at least one nozzle 8a or the nozzles 8A or 8B from the retracted position into the extracted operating position comprise a respective actuator 31.

As shown more clearly in FIGS. 2-3, 5-6, 9-10 and 12-13, the second movement means 26 comprise instead actuators 28 provided with sliding stems 29 for the independent movement of the at least one nozzle 8A or both the nozzles 8A, 8B along the respective directions X1, X2 perpendicular to the plane of extension n of the cutting disc 6.

The actuator 31 of the first movement means 22 and the actuators 28 of the second movement means 26 consist preferably of electric drives, in particular with a screw and female thread transmission.

As further shown in FIGS. 2-3, 5-6, 9-10 and 12-13, the stems 29 of the actuators 28 of the second movement means 26 pass through the slide 24 disclosed above and are slidable, inside respective passages 33 formed in the slide 24, between a retracted position and an extended position along the directions of movement X1, X2 perpendicular to the plane of extension π of the cutting disc 6.

As shown more clearly in FIGS. 5-6 and 12-13, the bodies 16 of the nozzles 8A, 8B with the respective supply lines 18 for the water with abrasive are mounted on the ends of the stems 29 of the actuators 28.

In the first configuration and in the third configuration shown in FIGS. 5 and 12, the axis of extension Y of the nozzles 8A, 8B, i.e. of their bodies 16, is perpendicular to the directions of movement X1, X2.

In the second configuration and in the fourth configuration shown in FIGS. 6 and 13, the axis of extension Y of the nozzles 8A, 8B, i.e. of their bodies 16, is oriented with an angle of inclination α of between 1° and 6° with respect to the plane of extension π of the cutting disc 6.

The positioning means 25, at the ends of the stems 29, may comprise devices, not shown in the attached figures, which are designed to adjust the inclination of the nozzles 8A, 8B, within the aforementioned range, relative to the plane of extension π of the cutting disc 6.

In a manner known per se, the first displacement means 12, the second displacement means 14, the first movement means 22 and the second movement means 24, the drives and the means for rotation of the head 10 are connected to a control unit designed to regulate operation thereof (not shown in the attached drawings).

The regulation by the control unit furthermore allows the cutting disc 6 and the at least one nozzle 8A or the nozzles 8A, 8B to be simultaneously activated.

Advantageously, the support head 10 may also be provided with retractable suction cups, not shown in the attached figures, designed to pick up and move on the support bench 2 the slab elements L obtained by means of cutting with the disc 6 and/or with the waterjets and abrasive.

As mentioned above, the present invention also relates to a method for cutting slabs L of stone or ceramic or glass material, which uses advantageously the cutting machine 1 described above.

The cutting method comprises the following steps:
i) positioning the slab L on a support bench 2 having a top surface;
ii) forming a cutting groove S in the slab L by means of displacement of a cutting disc 6 along a respective straight cutting direction; during this step, the cutting disc 6 penetrates into the thickness of the slab L to a predetermined depth or distance from the top surface of the support bench 2;
iii) further cutting of the slab along the cutting direction by means of a high-pressure waterjet with abrasive emitted by at least one nozzle 8A.

The method envisages, before step iii) or during step iii), a step for positioning the at least one nozzle 8A behind the cutting disc 6 with orientation of the nozzle 8A such that the waterjet with abrasive enters into the groove S formed by the cutting disc 6 and strikes a bottom vertex thereof, completing cutting of the slab L over the whole thickness.

Then, following the positioning step, the at least one nozzle 8A is arranged behind and slightly offset with respect to the cutting disc 6 along the cutting direction.

As already mentioned with reference to the cutting machine 1, the top surface of the support bench 2 is formed by a metal grid 5; the step i) is performed by positioning the slab L with the bottom surface directly in contact with the metal grid 5.

Advantageously, step iii) is performed by means of high-pressure waterjets emitted by the pair of nozzles 8A, 8B disclosed above with reference to the cutting machine 1.

The positioning and/or orientation of the at least one nozzle 8A, or of the nozzles 8A, 8B where a pair of nozzles 8A, 8B is provided, are performed by means of the positioning means 25, namely by means of the second movement means 26, of the machine 1, as disclosed above.

Advantageously, step ii) for forming the cutting groove S and step iii) for further cutting the slab are performed at the same time and simultaneously along the cutting direction, i.e. during a single pass of the machining unit 4.

During the respective step ii) for forming the cutting groove S, the disc 6 is kept at a distance or height from the top surface of the support bench 2, i.e. of the metal grid 5, preferably equal to about 1-2 mm.

In this way, the cutting disc 6 does not cut completely through the entire thickness of the slabs L positioned on the metal grid 5 of the support bench 2 and therefore does not affect the blades of the grid 5, limiting the wear thereof.

In accordance with this latter operating mode, the speed of movement of the cutting disc 6 may also be set to values higher than the values indicated above.

Thereafter, and as shown in FIGS. 5-7 and 12-14 with reference to the different configurations, the cut is completed by the nozzle 8A or the nozzles 8A, 8B with high-pressure waterjets which enter into the groove S formed by the disc 6, strike the bottom vertices of the groove S and cut the residual thickness of the material.

If the support head 10 is provided with suction-cup devices able to displace the cut slab elements and in order to prevent intersecting cuts and therefore collision of the disc 6 with the adjacent elements, after displacing the adjacent elements, it is no longer necessary to slow down the head 10 in order to complete cutting of the adjacent elements.

Alternatively, if the support head 10 does not have suction-cup devices and the cutting direction intersects another cutting direction, for example in order to form different-size quadrangular elements, in order to avoid cutting into the other element, the support head 10 is first slowed down and then raised in order to disengage the cutting disc 6 from the slab L while the nozzles 8A, 8B are further lowered by the same amount in order to complete the cut through the entire thickness of the slab L, reducing at the same time the movement speed of the head 10 and adapting it to that of the nozzles 8A, 8B.

From the above description it is now clear how the machine and the method for cutting slabs according to the present invention are able to achieve advantageously the predefined objects.

In particular, the provision of the at least one nozzle or nozzles behind the cutting disc and the use of positioning means, i.e. of the second movement means, allows the nozzles to be positioned and directed with respect to the cutting disc in a suitable and precise manner.

As a result of this arrangement, it is possible to avoid the use of the disposable element and at the same time limit the wear of the metal grid, reducing the maintenance operations required of the machine.

Furthermore, the advantages indicated above obtained with the cutting machine and method according to the present invention do not adversely affect the slab cutting quality and the precision which, on the contrary, are improved compared to the machines known in the field.

Obviously, the above description of embodiments applying the innovative principles of the present invention is provided by way of example of these innovative principles and must therefore not be regarded as limiting the scope of the rights claimed herein.

1. A machine for cutting slabs made of stone or ceramic or glass material, comprising:
a support bench for the slabs to be cut;
a machining unit comprising at least one nozzle for cutting the slabs by means of high-pressure waterjet with abrasive and a cutting disc designed to form a groove in the slabs along a cutting direction, said cutting disc and said at least one nozzle being mounted on a support head;
first displacement means and second displacement means intended to displace the machining unit at least along the cutting direction and along a vertical direction perpendicular to the support bench, respectively; and
first movement means configured to move said at least one nozzle with respect to said support head from a retracted or rest position into an extracted operating position, and vice versa;
wherein said machine comprises positioning means configured to place said at least one nozzle behind said cutting disc along the cutting direction with an orientation such that the waterjet enters into the groove formed by the cutting disc and strikes a bottom vertex thereof and in that said at least one nozzle and said cutting disc are activated simultaneously during displacement along the cutting direction.

2. The machine according to claim 1, characterized in that said machining unit comprises a pair of nozzles and said cutting disc lies in a plane of extension, said positioning means being configured to position said nozzles behind the cutting disc along the cutting direction and on opposite sides of the plane of extension of said cutting disc with an orientation such that the respective waterjets enters into the groove formed by the cutting disc and strike the two bottom vertices thereof, said nozzles and said cutting disc being activated simultaneously during displacement along the cutting direction.

3. The machine according to claim 1, characterized in that said positioning means are configured to direct said at least one nozzle or said nozzles with an angle of inclination of between 1° and 6° relative to the plane of extension of said cutting disc.

4. The machine according to claim 1, characterized in that said positioning means comprises second movement means configured to move said at least one nozzle or said nozzles with respect to said support head at least along a direction of movement or along respective movement directions perpendicular to the plane of extension of said cutting disc.

5. The machine according to claim 4, characterized in that said second movement means are configured to move at least one of said nozzles or both said nozzles along respective directions of movement perpendicular to the plane of extension of said cutting disc.

6. The machine according to claim 1, characterized in that said at least one nozzle or said nozzles are mounted on a slide, said slide being moved by said first movement means which act on said slide.

7. The machine according to claim 4, characterized in that said at least one nozzle or said nozzles are mounted on a slide, said second movement means comprising respective actuators for independently moving said at least one nozzle or said nozzles along respective directions perpendicular to the plane of extension of said cutting disc.

8. The machine according to claim 7, characterized in that the stems of the actuators of said second movement means pass through said slide and are slidable between a retracted position and a position extended along said directions of movement perpendicular to the plane of extension of said cutting disc.

9. The machine according to claim 7, characterized in that said at least one nozzle or said nozzles is/are mounted on respective bodies, said bodies being mounted at the ends of the stems of said actuators with an axis of extension of the nozzles, perpendicular to said directions of movement.

10. The machine according to claim 7, characterized in that said at least one nozzle or said nozzles is/are mounted on respective bodies, said bodies being mounted at the ends of the stems of said actuators with an axis of extension of the nozzles, oriented with an angle of inclination of between 1° and 6° relative to the plane of extension of said cutting disc.

11. The machine (1) according to claim 4, characterized in that said first movement means and said second movement means comprise actuators consisting of electric drives.

12. The machine according to claim 1, characterized in that said support bench consists of a tank intended to contain water and a metal grid positioned over the top opening of said tank, said metal grid being intended to come directly into contact with the bottom surface of the slabs to be cut.

13. The machine according to claim 1, characterized in that said support head is a bi-rotational fork head which has a vertical axis of rotation and a horizontal axis of rotation, said cutting disc and said at least one nozzle or said nozzles being mounted on a support of said head rotatable about said horizontal axis.

14. The machine according to claim 1, characterized in that the second displacement means are configured to keep the cutting disc in the operating position at a predetermined distance or height from the top surface of the support bench, namely of the grid, while the disc penetrates into the slab in order to make the cut and form the groove.

15. The machine according to claim 1, characterized in that said first displacement means comprise a beam mounted slidably at the ends thereof on respective support structures or transverse shoulders and a carriage mounted slidably along said beam, said second displacement means comprising a sleeve mounted on said carriage and intended to displace said machining unit along said vertical direction perpendicular to the support bench.

16. The machine according to claim 1, characterized in that said first displacement means and said second displacement means consist of an anthropomorphic robotic arm for displacement of the machining unit along at least the cutting direction and along the vertical direction.

17. The machine according to claim 1, characterized in that said support head is provided with retractable suction cups designed to pick up and displace the slab elements placed on said support bench and obtained by means of cutting with the disc and/or waterjets and abrasive.

18. A method for cutting slabs made of stone or ceramic or glass material by means of the cutting machine according to claim 1, the method comprising the following steps:
(i) positioning the slab on a support bench having a top surface;
(ii) forming a cutting groove in the slab by means of displacement of a cutting disc along a cutting direction, said disc penetrating into the thickness of the slab to a predetermined depth or distance from the top surface of the support bench;
(iii) further cutting of the slab along the cutting direction by means of a high-pressure waterjet emitted by at least one nozzle;
characterized in that, before or during said step (iii), a step involving positioning of the at least one nozzle behind the cutting disc is performed, so that the at least one nozzle has an orientation such that the waterjet enters into the groove formed by said cutting disc and strikes a bottom vertex thereof, completing cutting of the slab through the entire thickness.

19. The m method according to claim 18, characterized in that said step (ii) of forming the cutting groove and said further cutting step (iii) are performed simultaneously along said cutting direction.

20. The m method according to claim 18, characterized in that the top surface of said support bench is formed by a metal grid, said step (i) being carried out by positioning the slab with its bottom surface directly in contact with said grid.

21. The m method according to claim 18, characterized in that, during said step (ii), the cutting disc is kept at a distance or height from the top surface, namely from the metal grid, of the support bench equal to about 1-2 mm.

22. The m method according to claim 18, characterized in that said step (iii) is performed by means of high-pressure waterjets emitted by a pair of nozzles, before or during said step (iii), there being provided a step of positioning the nozzles behind the cutting disc, so that the nozzles have an orientation such that the waterjets enter into the groove and strike the bottom vertices thereof, completing cutting of the slab through the entire thickness.
